(19) United States
(12) Patent Application Publication
(10) Pub. No.: US 2026/0143382 A1
(43) Pub. Date: May 21, 2026

(54) METHOD AND SYSTEM FOR CASCADED NEAR REAL-TIME RAN INTELLIGENT CONTROLLERS IN A MOBILE NETWORK

(71) Applicant: Quanta Cloud Technology Inc., Taipei City (TW)

(72) Inventors: Chia-Hsin Huang, Taipei City (TW); Chia-Jui Lee, Taipei City (TW); Ji-Jeng Lin, Taipei City (TW)

(21) Appl. No.: 18/949,659

(22) Filed: Nov. 15, 2024

(51) Int. Cl. H04W 28/086; H04L 41/16; H04W 28/08

(52) U.S. Cl. CPC H04W 28/0862; H04L 41/16; H04W 28/0867

(57) ABSTRACT

A cascaded near-real time radio access network intelligent controller that may perform E2 node functions as well as near-real time radio access network intelligent controller functions is disclosed. The cascaded near-real time radio access network intelligent controller includes an A1 termination allowing communication to another near-real time radio access intelligent controller through a network. An E2 termination allows communication to an E2 node and the another near-real time radio access intelligent controller through the network. A controller executes a radio access network function for the E2 node through the E2 network termination. An E2 agent component allows performance of an E2 function by the controller in response to requests from the another near-real time radio access network intelligent controller via the E2 termination.

### TECHNICAL FIELD

The present disclosure relates generally to mobile wireless networks. More particularly, aspects of this disclosure relate to a system that allows intelligent controllers to function as E2 nodes in a radio access network (RAN) system to cascade access to other intelligent controllers.

### BACKGROUND

Mobile devices (e.g., cell phones) have become an indispensable tool for daily communication, entertainment, banking, and various other essential activities. Such activities require high quality of services (QoS, e.g., high bandwidth and low latency) for the mobile devices. In order to meet demands for wireless data traffic that the current 4G communication systems are unable to meet, the next generation communication system termed a 5G communication system, or 5G for short, was developed and standardized by the 3^{rd} generation partnership project (3GPP). Based on that project, the open radio access network (O-RAN) alliance further defines a radio access network (RAN) interface and an O-RAN architecture that allows interoperability of O-RAN solutions.

An O-RAN system may refer to a network system implemented based on O-RAN standards. Functions capable of being performed by a base station (eNB) of the existing 4G mobile communication systems and a base station (gNB) of a 5G mobile communication system are logically separated and implemented. An O-RAN base station providing mobile communication services is a cell site that includes a data processing unit (a digital unit or a distributed unit (DU)), a wireless transceiver (radio unit or remote unit (RU)) that communicates with user devices, and a central unit (CU) coupled to the DU. Current mobile communication requires multiple cell sites as users and traffic increase. The O-RAN system may include a RAN intelligent controller (RIC) for performing various types of management including resource allocation between the base station and a core network. The RIC is an element for improving quality of service for user equipment (UE) such as mobile devices, and may provide optimal cellular communication to the UE through the optimization of elements and resources of the O-RAN system.

A near real time radio access network intelligent controller (nRT-RIC) is a software-defined component of the Open RAN standard and is used to control and optimize RAN functions. FIG. 1 shows a known RAN system 10 that includes groups of E2 nodes 12 and 14. The E2 nodes in the E2 node groups 12 and 14 represent DUs and CUs. Each group of E2 nodes 12 and 14 are in communication with a respective nRT-RIC 16 and 18 that provide various services for the E2 nodes.

In E2 nodes such as DUs and the CUs, an E2 agent 20 acts as an interface handler enabling communication to nRT-RIC over an E2 interface 22. The E2 interface defines a set of E2 procedures enabling a near-real-time close loop automation between the nRT-RIC 16 and an E2 node in the group of E2 nodes 12. The E2 nodes also include various RAN functions 24 that offer manageability such as performance management, configuration management, and other applications 26 that perform other functions such as functions that support base station capabilities.

A service management and orchestration system 42 is the topmost management unit and manages the entire RAN system 10. The service management and orchestration system 42 enables the management of all nRT-RICs and E2 nodes using an O1 interface 30. The service management and orchestration system 42 includes a non-real time radio access network intelligent controller (nonRT-RIC) 44. The nRT-RICs such as the nRT-RICs 16 and 18 are respectively connected to the nonRT-RIC 44 and the service management and orchestration system 42 through an A1 interface 32 and the O1 interface 30 that serve as communication interfaces. The nonRT-RIC 44 enables a non-real-time control loop and the deployment of policy, guidance, and intelligent models in the nRT RIC 16 through the A1 interface 32.

In a large-scale open radio access network (O-RAN) communication system, nRT-RICs encounter scalability challenges since a single nRT-RIC instance may be unable to service massive numbers of E2 nodes in near real time (10 milliseconds to 1 second). Typically, a nRT-RIC instance needs to collect a set of key performance data from each of a large number of E2 nodes, analyze the data, and make optimal decisions to control the E2 nodes in near real time. Thus, multiple nRT-RIC instances may be employed to share computational workload. However, as defined by the O-RAN nRT-RIC framework and E2 interface specifications, the nRT-RIC framework does not offer an inter communication mechanism for exchanging information and sharing computational workload among nRT-RICs.

There are some current systems that may address the scalability issue of allocating multiple nRT-RICs to E2 nodes for a large-scale O-RAN communication system. However, those systems have various disadvantages. A specialized system may be developed for allocating E2 nodes, but building such specialized systems are expensive. Further such systems must be retrofitted to existing networks and may not be compatible to current specifications. In addition, new specialized systems may cause side effects of reimplementation to the existing nRT-RIC applications.

Thus, there is a need for an O-RAN communication system that increases scalability, flexibility, manageability, and resilience of nRT-RIC and E2 node deployment in order to enhance the quality of network optimization services. There is a need for a nRT-RIC that may be compatible with current specifications but allow distribution of workload with other nRT-RICs. There is also a need for a flexible architecture that allows different nRT-RICs to manage different E2 nodes.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One disclosed example is a radio access network including a first E2 node and a first cascaded near-real time radio access network intelligent controller including an E2 termination. The E2 termination is in network communication with the first E2 node. The first cascaded near-real time radio access network intelligent controller includes an E2 agent component allowing performance of E2 node functions. The first cascaded near-real time radio access network intelligent controller provides services to the first E2 node through the E2 termination. A second cascaded near-real time radio access network intelligent controller is in network communication with the first near-real time radio access network intelligent controller via the E2 termination. The first cascaded near-real time radio access network intelligent controller executes an E2 node function in response to the second cascaded near-real time radio access network intelligent controller communicating via the E2 termination.

A further implementation of the example network is where the first cascaded near-real time radio access network intelligent controller includes an A1 termination in network communication with the second cascaded near-real time radio access network intelligent controller. Another implementation is where the example network includes a non-real time radio access network intelligent controller in network communication with the cascaded second near-real time radio access network intelligent controller via the A1 termination. Another implementation is where the example network includes a root cascaded near-real time radio access network intelligent controller in network communication with the non-real time radio access network intelligent controller via the A1 termination. The root cascaded near-real time radio access network intelligent controller is in network communication with a plurality of cascaded near-real radio access network intelligent controllers via the A1 termination and the E2 termination. The plurality of cascaded near-real radio access network intelligent controllers includes the second cascaded near-real time radio access network intelligent controller. Another implementation is where the example network further includes a second E2 node and a third cascaded near-real time radio access network intelligent controller including an A1 termination in network communication with the second E2 node. The third cascaded near-real time radio access network intelligent controller includes an E2 termination in network communication with the second E2 node and the second near-real time radio access network intelligent controller. The third cascaded near-real time radio access network intelligent controller includes an E2 agent component allowing performance of E2 node functions. The third cascaded near-real time radio access network intelligent controller provides services to the second E2 node through the E2 agent. The second cascaded near-real time radio access network intelligent controller executes a radio access network function from the first E2 node via the E2 agent from the first cascaded near-real time radio access network intelligent controller and executes a radio access network function from the second E2 node via the E2 agent and E2 termination from the third near-real time radio access network intelligent controller. Another implementation is where the third cascaded near-real time radio access network intelligent controller is added to the network by establishing network communication with the second cascaded near-real time radio access network intelligent controller for horizontal scaling of the network. Another implementation is where a registration process is executed by the first cascaded near-real time radio access network intelligent controller to allow the second cascaded near-real time radio access network intelligent controller to provide services to the first E2 node. Another implementation is where the first E2 node is one of a plurality of E2 nodes supported by the first cascaded near-real time radio access network intelligent controller. Another implementation is where the first cascaded near-real time radio access network intelligent controller is compatible with the O-RAN standard. Another implementation is where the first cascaded near-real time radio access network intelligent controller includes a node ID that identifies the capability to perform E2 node functions in E2 communication with the second cascaded near-real time radio access network intelligent controller. Another implementation is where the network is operable to add a third cascaded near-real time radio access network intelligent controller by establishing network communication between the third cascaded near-real time radio access network intelligent controller to the first cascaded near-real time radio access network intelligent controller. The third cascaded near-real time radio access network intelligent controller executes an E2 node function in response to the first cascaded near-real time radio access network intelligent controller communicating via the E2 termination.

Another disclosed example is a method of servicing E2 nodes in a mobile communication network. A parent cascaded near-real time radio access network intelligent controller is established. Network communication between the parent cascaded near-real time radio access network intelligent controller to a child cascaded near-real time radio access network intelligent controller is established via an E2 termination. An E2 node is serviced through network communication to the child cascaded near-real time radio access network intelligent controller via the E2 termination. An E2 node function is performed via an E2 agent of the child cascaded near-real time radio access network intelligent controller in response to a request from the parent cascaded near-real time radio access network intelligent controller via the E2 termination.

Another implementation of the example method a non-real time radio access network intelligent controller in network communication with the parent cascaded near-real time radio access network intelligent controller via an A1 termination. Another implementation is where the example method includes the parent cascaded near-real time radio access network intelligent controller executing a radio area access network function from the child cascaded near-real time radio access network intelligent controller via the E2 termination of the parent cascaded near-real time radio access network intelligent controller to the E2 agent of the child cascaded near-real time radio access network intelligent controller. Another implementation is where the E2 node is one of a plurality of E2 nodes supported by the child cascaded near-real time radio access network intelligent controller. Another implementation is where the child cascaded near-real time radio access network intelligent controller is compatible with the O-RAN standard.

Another disclosed example is a cascaded near-real time radio access network intelligent controller including an E2 termination allowing communication to an E2 node and another cascaded near-real time radio access intelligent controller through the network. A controller executes a radio access network function for the E2 node through the E2 termination. An E2 agent component allows performance of an E2 function by the controller in response to requests from the another cascaded near-real time radio access network intelligent controller via the E2 termination.

A further implementation of the example cascaded near-real time radio access network intelligent controller is where the cascaded near-real time radio access network intelligent controller is compatible with the O-RAN standard. Another implementation is where the example cascaded near-real time radio access network intelligent controller includes a node ID that identifies the capability to perform E2 node functions. The controller sends the node ID in E2 communications with the another cascaded near-real time radio access intelligent controller. Another implementation is where the cascaded near-real time radio access intelligent controller includes an A1 termination allowing communication to the another cascaded near-real time radio access intelligent controller through the network. The controller is operable to perform an A1 function in response to the another cascaded near-real time radio access network intelligent controller communicating via the A1 termination.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a block diagram of a prior art open radio access network (O-RAN) system that may be a mobile network;

FIG. 2 is a block diagram of an example cascaded radio access network intelligent controller (nRT-RIC) in a RAN that allows a cascade architecture to manage E2 nodes;

FIG. 3A is a block diagram of a prior art radio network architecture including nRT-RICs;

FIG. 3B is a block diagram of an example radio network architecture that may be constructed using the example cascaded radio access network intelligent controller in FIG. 2 to allow servicing of an E2 node by multiple near-real time RAN intelligent controllers; and

FIG. 4 is a diagram of a RAN that allows a cascading architecture using cascaded near-real time RAN intelligent controllers that may operate as E2 nodes.

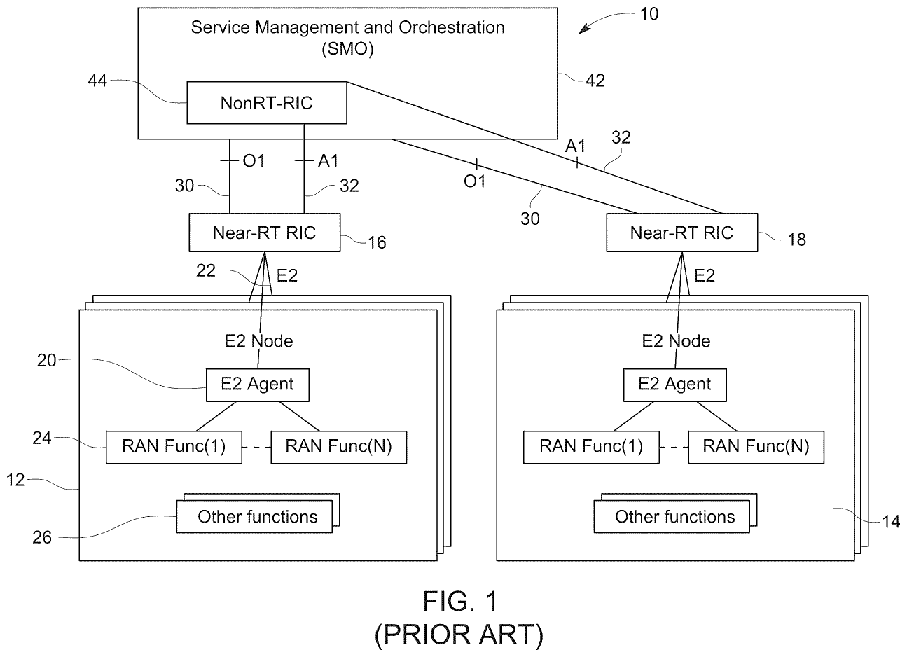

### DETAILED DESCRIPTION OF THE ILLUSTRATED EMBODIMENTS

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The present disclosure relates to a cascaded near-real-time radio access network intelligent controller (CnRT-RIC) that allows the deployment of a RAN architecture that resolves the compatibility, scalability, and inter-RIC optimization issues of existing RANs in supporting E2 nodes. The inter-RIC optimization issues result from a standard near-real-time radio access network intelligent controller (nRT-RIC) being unable to make a proper decision since there is no communication mechanism for the nRT-RIC to obtain sufficient information from E2 nodes serviced by other nRT-RICs. The example cascaded nRT-RIC is based on the design of the current O-RAN nRT-RIC framework with the addition of an E2 agent component that allows the nRT-RIC to perform E2 node functions and thus is compatible with the O-RAN standards. Thus, the example cascaded nRT-RIC may be viewed as a “super” E2 node, which itself can both service E2 nodes and be serviced by another cascaded nRT-RIC.

The example architecture that incorporates cascaded nRT-RICs that can perform both as an E2 node and as an nRT-RIC has several advantages. The example cascaded nRT-RIC is fully compatible with the O-RAN E2 specification such that previous development of applications can be leveraged in the example cascaded nRT-RIC without side effects. The example cascaded nRT-RIC requires a minimal change of the O-RAN nRT-RIC design framework of adding an E2 agent component, which is currently employed in E2 nodes. The example architecture facilitates distribution of computational workload for collecting and analyzing E2 node data to multiple cascaded nRT-RICs. The architecture may enable inter-RIC communication capabilities for cascaded nRT-RICs to better support use cases encountering inter-RIC optimization issues.

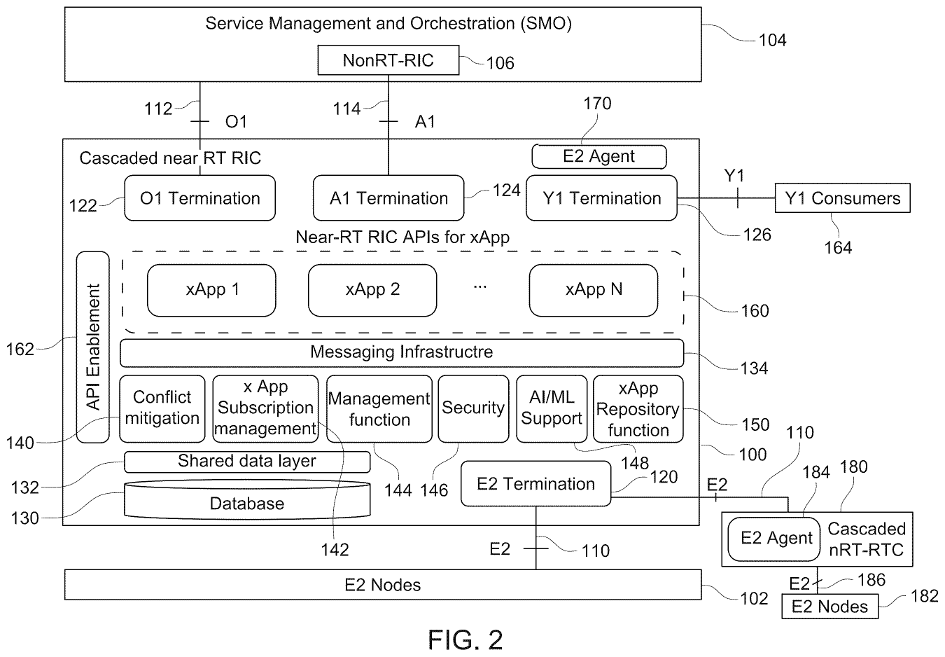

FIG. 2 shows a detailed architecture diagram of an example cascaded nRT-RIC 100 in network communication with a series of E2 nodes 102 and a service management and orchestration (SMO) system 104 that includes a non-real-time radio access network intelligent controller (nonRT-RIC) 106. The cascaded nRT-RIC 100 is in network communication with the E2 nodes 102 through an E2 interface 110. The network communication with the SMO 104 and nonRT-RIC 106 occurs through an O1 interface 112 and an A1 interface 114, respectively. The architecture of the cascaded nRT-RIC 100 includes an E2 termination 120, an O1 termination 122, an A1 termination 124, and a Y1 termination 126. The E2 termination (E2T) 120 is a process where the E2 interface 110 is managed and terminated.

The cascaded nRT-RIC 100 may execute a series of extended applications (xApp) 160 that use an API enablement 162. The applications 160 are a series of xApp modules that are pluggable functional extensions of the cascaded nRT-RIC 100 and are responsible for controlling and optimizing RAN functions and resources. To support the execution of the applications 160, the cascaded nRT-RIC 100 includes a database 130, a shared data layer 132, and a messaging infrastructure 134. Various functions are performed by the cascaded nRT-RIC 100 including a conflict mitigation function 140, an xApp subscription management function 142, a management function 144, a security function 146, an AL/ML support function 148, and an xApp repository function 150.

The service management and orchestration system 104 manages the entire RAN system. The cascaded nRT-RICs such as the cascaded nRT-RIC 100 are connected to the non-real time RIC 106 and the service management and orchestration system 104 through the A1 termination 124 and the O1 termination 122. The communication links formed by A1 termination 124, O1 termination 122, and E2 termination 120 are the A1, O1, and E2 interfaces 112, 114, and 110, respectively. The non-real time RIC 106 enables a non-real-time control loop and the deployment of policy, guidance, and machine learning (ML) intelligent models in connected the cascaded nRT RIC 100 through the A1 termination 124. The Y1 termination 126 provides an interface between the cascaded nRT-RIC 100 and Y1 consumers 164. The Y1 termination 126 enables RAN analytics information exposure from the nRT-RIC 100.

The above components are part of the current design of a nRT-RIC as defined by the O-RAN standards. The example cascaded nRT-RIC 100 includes an E2 agent component 170 that enables the cascaded nRT-RIC 100 to play the roles of a nRT-RIC and an E2 node. The added E2 agent component 170 enables a standard nRT-RIC to support E2 communication capabilities and allow collaboration between different layers of cascaded nRT-RICs such as the cascaded nRT-RICs 100 and another cascaded nRT-RIC 180. In this example, the parent cascaded nRT-RIC 100, via the E2 termination 120, may send an E2 request to a standard E2 node in the E2 nodes 102 or to the next level cascaded nRT-RIC 180 which is servicing E2 nodes 182. The child cascaded nRT-RIC 180 may also have an E2 agent component 184, which may receive and process the E2 request sent from the parent cascaded nRT-RIC 100. The child cascaded nRT-RIC 180 includes an E2 termination that is coupled to an E2 interface 186 that communicates with an E2 agent in the E2 nodes 182. The child cascaded nRT-RIC 180 may process the E2 request by executing a RAN function of an E2 node in the E2 nodes 182 or by executing a RAN function provided by the child cascaded nRT-RIC 180 itself. Similarly, an A1 request issued by the non-real time RIC 106 may be handled by the cascaded nRT-RIC 100 itself or be forwarded to the child cascaded nRT-RIC 180 depending on the target of the A1 request. The example cascaded nRT-RIC 100 may already support A1 bidirectional communication between a sender and a receiver as defined by O-RAN A1 specifications.

The added E2 agent component 170 for the example cascaded nRT-RIC performs like a bridge function that supports A1 and E2 network communications between parent and child cascaded nRT-RICs such as the cascaded nRT-RICs 100 and 180, respectively. The following are some technical details for the cascaded nRT-RICs. According to O-RAN E2 specifications, each E2 entity in a network communication has a globally unique identifier (ID) following a standard naming rule that is able to indicate the types of network entities such as “gNB-CU-UP” and “Near-RT RIC”. The example cascaded nRT-RIC 100 may extend the network entity naming rule by adding a new entity type for the cascaded nRT-RIC termed a “Cascaded Near-RT RIC”. Thus, by the entity ID in a received E2 message, a cascaded nRT-RIC may decide to consume the E2 message by itself or to forward the E2 message to the actual target entity which may be a standard E2 node, a standard nRT-RIC, or the example cascaded nRT-RIC. Similarly, when a cascaded nRT-RIC receives an A1 message sent from a non-real time-RIC or a parent cascaded nRT-RIC, the cascaded nRT-RIC may either consume the A1 message or forward the A1 message to a child cascaded nRT-RIC.

By the O-RAN E2 specifications, an E2 node may execute an E2 setup procedure to register to a nRT-RIC before the nRT-RIC interacts with the E2 node. During the registration process, the E2 node may report its capabilities information, including RIC function information and E2 node configuration, to the nRT-RIC such that the nRT-RIC may be knowledgeable to properly interact with the E2 node. Similarly, with the E2 agent component 170, the example child cascaded nRT-RIC such as the cascaded nRT-RIC 180 playing the role of an E2 node may also register to a parent cascaded nRT-RIC. In this instance, the child cascaded nRT-RIC 180 may have serviced some E2 nodes such as the E2 nodes 182. The child cascaded nRT-RIC 180 may encapsulate the capabilities indicated in registration information of the E2 nodes 182 and capabilities of the child cascaded nRT-RIC 180 itself. The child cascaded nRT-RIC 180 then registers to the parent cascaded nRT-RIC 100 by providing the consolidated capability information during the registration process. With the consolidated registration information, the parent cascaded nRT-RIC 100 may directly interact with the child cascaded nRT-RIC 180 or indirectly command a specific E2 node in the E2 nodes 182 via the child cascaded nRT-RIC 180.

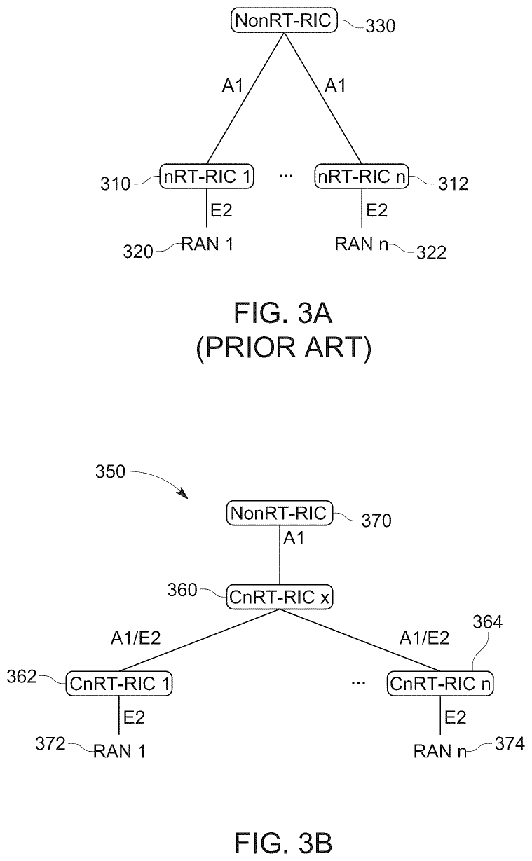

FIG. 3A and FIG. 3B show the differences between a conventional architecture that only uses standard nRT-RICs and an architecture that may use the example cascaded nRT-RIC 100. FIG. 3A shows a prior art deployment architecture 300 where nRT-RICs 310 and 312 each directly connect to a RAN with separate groups of respective E2 nodes 320 and 322. The nRT-RICs 310 and 312 communicate via the respective E2 interfaces with the E2 nodes 320 and 322. Each of the nRT-RICs 310 and 312 are connected to a non-real time RIC 330 via their respective A1 interfaces. The prior art architecture in FIG. 3A does not allow E2 nodes 320 to be serviced by the nRT-RIC 312 or the E2 nodes 322 to be serviced by the nRT-RIC 310. The prior art architecture may also lack of inter-communication between the nRT-RICs 310 and 312 and may cause the inter-RIC optimization issue which may degrade the performance of the nRT-RICs 310 and 312.

In the example architecture 350 in FIG. 3B, there are several relations between the cascaded nRT-RICs at the different levels. The lowest level of cascaded nRT-RICs, such as the cascaded nRT-RIC 362 and 364, may be children of a parent cascaded nRT-RIC such as the cascaded nRT-RIC 360. The lowest level of cascaded nRT-RICs also termed as a base level, such as the cascaded nRT-RICs 362 and 364, directly connect to RANs that include the E2 nodes. The cascaded nRT-RICs of the same parent cascaded nRT-RIC 430 are termed siblings, such as the cascaded nRT-RICs 362 and 364. A cascaded nRT-RIC that directly connects to a non-real time-RIC 450 is termed the root level, such as a root cascaded nRT-RIC 440.

In contrast to FIG. 3A, FIG. 3B shows a cascading deployment architecture 350 that utilizes the capabilities of the cascaded nRT-RIC, such as the cascaded nRT-RIC 100 in FIG. 2. In this example, a parent cascaded nRT-RIC 360 is connected between two children cascaded nRT-RICs 362 and 364, and a non-real time RIC 370. The parent cascaded nRT-RIC 360 is connected to the non-real time RIC 370 via the A1 interface and is connected via both the A1 interface and the E2 interface to the children cascaded nRT-RICs 362 and 364. The children cascaded nRT-RICs 362 and 364 service respective RAN groups of E2 nodes 372 and 374 through respective E2 interfaces. Although only two children cascaded nRT-RICs 362 and 364 are shown for simplicity, it is to be understood that any number of children cascaded nRT-RICs at the same level may be supported by the architecture 350.

In this example, the parent cascaded nRT-RIC 360 views the children cascaded nRT-RICs 362 and 364 as “super” E 2 nodes as identified by the respective entity IDs with an example “Cascaded Near-RT RIC” type. After completeness of registration process, the cascaded nRT-RICs 362 and 364 may have capabilities information from the registered E2 nodes in RANs 372 and 374. The parent cascaded nRT-RIC 360 may also have capabilities information from the cascaded nRT-RICs 362 and 364. Therefore, the parent cascaded nRT-RIC 360 may directly obtain performance and status data of E2 nodes in the RANs 372 and 374 via respective RAN functions of cascaded nRT-RICs 362 and 364. The cascaded nRT-RIC 360 then may analyze the data and issue control commands to the children cascaded nRT-RICs 362 and 364 via respective RAN functions of the cascaded nRT-RICs 362 and 364. The cascaded nRT-RICs 362 and 364 finally may issue corresponding control commands to the E2 nodes in RANs 372 and 374 via the respective RAN functions of the E2 nodes.

Similarly, when the cascaded nRT-RIC 360 receives an A1 request from the non-real time RIC 370 via an A1 interface, the cascaded nRT-RIC 360 can handle the A1 request directly or forward the A1 request to the corresponding children cascaded nRT-RICs 362 and 364 to process the A1 request depending on the target of the A1 request.

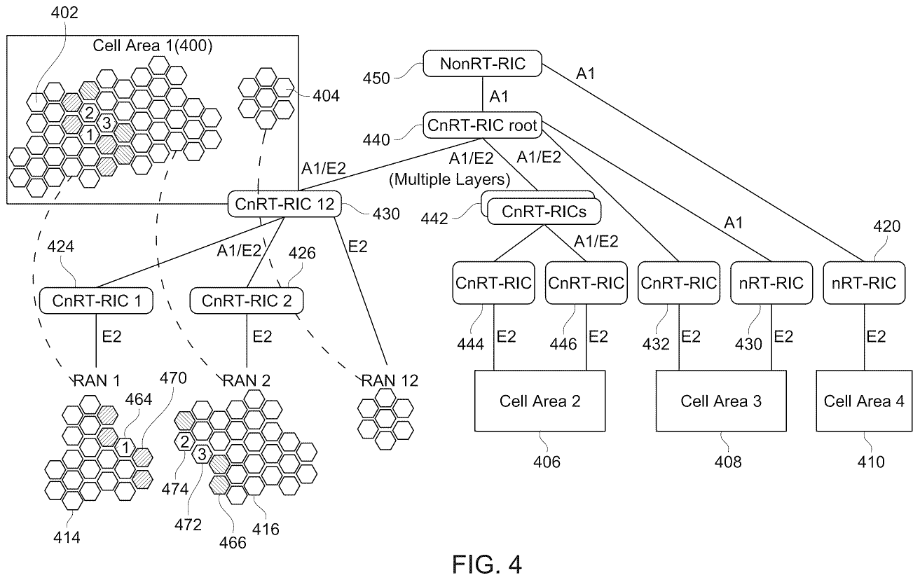

FIG. 4 shows an example of a cell area 400 that includes numerous E2 nodes (a combination of a CU and a DU E2 nodes forms an individual cell in the cell area 400) that are serviced by an example cascaded nRT-RIC architecture. In this example, the area 400 is divided into several cell areas such as 402 and 404. In this example, the cell area 402 is serviced by two cascaded nRT-RICs 424 and 426, which respectively service groups of E 2 nodes 414 and 416. The cell area 404 is serviced by the cascaded nRT-RICs 430. The cascaded nRT-RICs 424 and 426 are serviced by a parent cascaded nRT-RIC 430 via an E2 interface and an A1 interface. Furthermore, a root cascaded nRT-RIC 440 is responsible for coordination of all cascaded nRT-RICs at all lower levels and communication to the non-real time RIC 450. The non-real time RIC 450 may be coupled to a plurality of the root cascaded nRT-RICs via an A1 interface, but only a single root cascaded nRT-RIC 440 is shown in FIG. 4 for explanation purposes.

The example cascaded nRT-RIC technology may have compatibility, scalability, and inter-RIC optimization characteristics. First, the example cascaded nRT-RIC architecture may be compatible and capable to cooperate with standard nRT-RICs. In this example, the architecture services other cell areas including cell area 406, cell area 408, and cell area 410. In this example, the cell area 410 may be serviced via an E2 interface by a standard nRT-RIC 420. The nRT-RIC 420 may have direct communication with the non-real time RIC 450 via the A1 interface. In contrast, the cell area 408 may be collaboratively serviced by standard nRT-RICs such as a nRT-RIC 430 (without the E2 agent) and cascaded nRT-RICs such as a cascaded nRT-RIC 432 (with an E2 agent).

Second, the scalability of the cascaded nRT-RIC architecture may grow horizontally and vertically. The cell area 406 is serviced by two branches of the cascaded nRT-RIC 442 rooted by the cascaded nRT-RIC 440. The cascaded nRT-RIC 442 in the example may represent vertical multiple layers of cascaded nRT-RICs. Thus, additional layers of cascaded nRT-RICs may be added to between a root cascaded nRT-RICs such as to the root nRT-RIC 440 and any children cascaded nRT-RICs such as the cascaded nRT-RIC 442 to allow vertical scaling of the architecture by the system operator. Alternatively, there may be an automated routine to vertically scale the architecture to add additional cascaded nRT-RICs based on network needs. The vertical scalability ability of the example architecture may meets the needs of administrative hierarchy management, such as classification of the network into different hierarchical levels such as national, state, city, and county levels. Vertical scalability offers flexibilities for a mobile network service provider to deploy and manage the mobile network to address the needs of such different levels depending on the scale of the network.

The two branches of the cascaded nRT-RIC 442 each have a cascaded nRT-RIC 444 and 446. Each cascaded nRT-RIC in the network architecture may service a group of E2 nodes such as those in the cell area 406. Additional cascaded nRT-RICs may be added by network connection of such cascaded nRT-RICs to the parent cascaded nRT-RIC 442 to allow horizontal scaling of the architecture. As the number of cascaded nRT-RICs increases, the number of serviced E2 nodes (cells) also increases. Therefore, scalability challenges may be addressed by the cascaded nRT-RIC.

The above vertical and horizontal scalability may be accomplished with assistance from the service management and orchestration (SMO) system 104 as shown in FIG. 2. One crucial task performed by the service management and orchestration system 104 is service orchestration, e.g., the process of designing, creating, delivering, and monitoring service offerings. In the above example, the cascaded nRT-RICs 444 and 446 both may be computationally overloading to service the E2 nodes in cell area 406. The overloading event may be detected by the service management and orchestration system 104 via the O1 interface (not shown in FIG. 4). The service management and orchestration system 104 first will check whether there is a server with available computational capacity that may accommodate a new cascaded nRT-RIC service. For horizontal scalability, if there is a server available with enough computational resources, the service management and orchestration 104 will create a new cascaded nRT-RIC service as a sibling cascaded nRT-RIC of the overloading cascaded nRT-RICs 444 and 446. Furthermore, if there are not enough computational resources available at the same level of the overloading cascaded nRT-RICs 444 and 446, the service management and orchestration 104 may then check whether there is a server available with computational capacity at parent (or higher) level which may accommodate a new cascaded nRT-RIC service. For vertical scalability, if there is a server available with enough computational resources, a new cascaded nRT-RIC may be created at the parent level.

Last, the cascaded nRT-RIC supports an inter-RIC optimization capability. A standard nRT-RIC may be unable to make a proper decision since the nRT-RIC may not obtain sufficient performance and configuration information of cells and user devices held by other nRT-RICs. However, in the example cascaded nRT-RIC architecture 400 in FIG. 4, the second level cascaded nRT-RIC 430 may be able to handle the inter-RIC optimization since the cascaded nRT-RIC 430 may obtain sufficient information from the base-level cascaded nRT-RICs 424 and 426. For example, a cell load balancing use case may have a user device with high bandwidth requirements in a signal overlap zone of the cell areas 414 and 416 with border cells 464 and 466, respectively. The user device connects to a border cell such as a cell 470 in the border cells 464 of the cell area 414. The user device may also receive signals from adjacent cells 472 and 474 in the border cell 466 of the cell area 416. In this example, the serving cell 470 may be overloaded with high traffic and may be unable to meet the traffic requirements for the user device. A standard nRT-RIC in the position of the cascaded nRT-RIC 424 that services the E 2 nodes of the cell 470 may detect the traffic overload event and may try to hand over the user device to one of the adjacent cells 472 or 474 of the cell area 416. However, the standard nRT-RIC has no cell load information of the adjacent cells 472 and 474 serviced by another nRT-RIC in the position of the cascaded nRT-RIC 426. Thus, the standard nRT-RIC may just force the user device to hand over to an adjacent cell such as the cell 472 with the strongest signal strength. However, it may be possible that the cell 472 is also overloading with high traffic and cannot provide enough radio resources to the user device. As a result, the standard nRT-RIC in the position of the cascaded nRT-RIC 426 may perform the cell traffic load balance process again, and may cause the user device to be handed over to another adjacent cell 474. In summary, the standard O-RAN nRT-RIC may suffer from the inter-RIC optimization issue and thus may impact the network performance and the quality of experience (QoS) for a user device.

In contrast, in the cascaded nRT-RIC architecture 400, a parent cascaded nRT-RIC, such as the cascaded nRT-RIC 430, can directly obtain sufficient cell information from the base-level cascaded nRT-RICs 424 and 426 through the E2 interfaces. The parent cascaded nRT-RIC 430 may also issue control commands to the cascaded nRT-RICs 424 and 426 that are functioning as super E2 nodes. Then, if necessary, the cascaded nRT-RICs 424 and 426 may forward the control commands to target E2 nodes in the cell areas 414 and 416. In this manner, the cascaded nRT-RIC 430 may perform some RIC functions, such as reconfiguring handover parameters of a cell provided by the base-level cascaded nRT-RICs 424 and 426. The RIC functions finally may be executed by the E2 nodes serviced by the base-level cascaded nRT-RICs 424 and 426 to force the user device serviced by the traffic overloaded cell 460 to connect to a proper cell 462 or 464 that is not traffic overloaded.

Furthermore, the second level cascaded nRT-RIC 430 logically serves the entire cell area 400 which is split into three cell areas 404, 414, and 416, respectively serviced by the cascaded nRT-RICs 430 and two base level cascaded nRT-RICs 424 and 426. The second level nRT-RIC 430 is suitable for performing inter-RIC optimization applications such as the mentioned cell load balancing while the base level cascaded nRT-RICs 424 and 426 may be responsible for performing intra-RIC optimization applications. For example, the cascaded nRT-RIC 426 may hand over a user device from the cell 472 that is experiencing traffic overload to the cell 474. Additionally, from the computational workload perspective, the second level cascaded nRT-RIC 430 may not experience computational overloading issues because the cascaded nRT-RIC 430 may only handle the E2 nodes servicing the border cells 474 and 476 via the respective base level cascaded nRT-RICs 424 and 426 while the cascaded nRT-RIC 430 leaves intra-RIC optimization applications to be handled by the base level cascaded nRT-RICs 424 and 426. Thus, although a parent cascaded nRT-RIC may logically serve a large number of cells, the computational workload for executing inter-RIC optimization services may be limited and affordable. For example, when a child cascaded nRT-RIC such as the nRT-RIC 426 is overloaded in computation, the service management and orchestration system may split the cell area 416 into two parts and create another cascaded nRT-RIC to share the computational workload for the overloaded cascaded nRT-RIC 426.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as an un-subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing un-subscription model can be composed of various characteristics such as, for example, on-demand self-service, broad network access, resource pooling, rapid elasticity, measured service, and so forth. A cloud-computing un-subscription model can also expose various service un-subscription models, such as, for example, Software as a Service (“SaaS”), a web service, Platform as a Service (“PaaS”), and Infrastructure as a Service (“IaaS”). A cloud-computing un-subscription model can also be deployed using different deployment un-subscription models such as private cloud, community cloud, public cloud, hybrid cloud, and so forth. In this description and in the claims, a “cloud-computing environment” is an environment in which cloud computing is employed.

In one example, a computing device may be configured to perform one or more of the processes described above. the computing device can comprise a processor, a memory, a storage device, an I/O interface, and a communication interface, which may be communicatively coupled by way of a communication infrastructure. In certain embodiments, the computing device can include fewer or more components than those described above.

In one or more embodiments, the processor includes hardware for executing instructions, such as those making up a computer program. As an example and not by way of limitation, to execute instructions for digitizing real-world objects, the processor may retrieve (or fetch) the instructions from an internal register, an internal cache, the memory, or the storage device and decode and execute them. The memory may be a volatile or non-volatile memory used for storing data, metadata, and programs for execution by the processor(s). The storage device includes storage, such as a hard disk, flash disk drive, or other digital storage device, for storing data or instructions related to object digitizing processes (e.g., digital scans, digital models).

The I/O interface allows a user to provide input to, receive output from, and otherwise transfer data to and receive data from computing device. The I/O interface may include a mouse, a keypad or a keyboard, a touch screen, a camera, an optical scanner, network interface, modem, other known I/O devices or a combination of such I/O interfaces. The I/O interface may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface is configured to provide graphical data to a display for presentation to a user. The graphical data may be representative of one or more graphical user interfaces and/or any other graphical content as may serve a particular implementation.

The communication interface can include hardware, software, or both. In any event, the communication interface can provide one or more interfaces for communication (such as, for example, packet-based communication) between the computing device and one or more other computing devices or networks. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI.

Additionally, the communication interface may facilitate communications with various types of wired or wireless networks. The communication interface may also facilitate communications using various communication protocols. The communication infrastructure may also include hardware, software, or both that couples components of the computing device to each other. For example, the communication interface may use one or more networks and/or protocols to enable a plurality of computing devices connected by a particular infrastructure to communicate with each other to perform one or more aspects of the digitizing processes described herein. To illustrate, the image compression process can allow a plurality of devices (e.g., server devices for performing image processing tasks of a large number of images) to exchange information using various communication networks and protocols for exchanging information about a selected workflow and image data for a plurality of images.

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer to-peer networks).

The operations described in this specification can be implemented as operations performed by a “control system” on data stored on one or more computer-readable storage devices or received from other sources.

The term “control system” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A radio access network comprising:
a first E2 node;
a first cascaded near-real time radio access network intelligent controller including an E2 termination in network communication with the first E2 node, the first cascaded near-real time radio access network intelligent controller including an E2 agent component allowing performance of E2 node functions, wherein the first cascaded near-real time radio access network intelligent controller provides services to the first E2 node through the E2 termination; and
a second cascaded near-real time radio access network intelligent controller in network communication with the first cascaded near-real time radio access network intelligent controller via the E2 termination, wherein the first cascaded near-real time radio access network intelligent controller executes an E2 node function in response to the second cascaded near-real time radio access network intelligent controller communicating via the E2 termination.

2. The radio access network of claim 1, wherein the first cascaded near-real time radio access network intelligent controller includes an A1 termination in network communication with the second cascaded near-real time radio access network intelligent controller.

3. The radio access network of claim 2, further comprising a non-real time radio access network intelligent controller in network communication with the second cascaded near-real time radio access network intelligent controller via the A1 termination.

4. The radio access network of claim 3, further comprising a root cascaded near-real time radio access network intelligent controller in network communication with the non-real time radio access network intelligent controller via the A1 termination, wherein the root cascaded near-real time radio access network intelligent controller is in network communication with a plurality of cascaded near-real radio access network intelligent controllers via the A1 termination and the E2 termination, wherein the plurality of cascaded near-real radio access network intelligent controllers includes the second cascaded near-real time radio access network intelligent controller.

5. The radio access network of claim 1, further comprising:
a second E2 node; and
a third cascaded near-real time radio access network intelligent controller including an A1 termination in network communication with the second cascaded near-real time radio access network intelligent controller and an E2 termination in network communication with the second E2 node, the third cascaded near-real time radio access network intelligent controller including an E2 agent component allowing performance of E2 node functions, wherein the third cascaded near-real time radio access network intelligent controller provides services to the second E2 node through the E2 agent; and
wherein the second cascaded near-real time radio access network intelligent controller executes a radio access network function from the first E2 node via the E2 agent from the first cascaded near-real time radio access network intelligent controller and executes a radio access network function from the second E2 node via the E2 agent and E2 termination from the third near-real time radio access network intelligent controller.

6. The radio access network of claim 5, wherein the third cascaded near-real time radio access network intelligent controller is added to the network for horizontal scaling of the network by establishing network communication with the second cascaded near-real time radio access network intelligent controller.

7. The radio access network of claim 1, wherein a registration process is executed by the first cascaded near-real time radio access network intelligent controller to allow the second cascaded near-real time radio access network intelligent controller to provide services to the first cascaded near-real time radio access network intelligent controller and the first E2 node.

8. The radio access network of claim 1, wherein the first E2 node is one of a plurality of E2 nodes supported by the first cascaded near-real time radio access network intelligent controller.

9. The radio access network of claim 1, wherein the first cascaded near-real time radio access network intelligent controller is compatible with the O-RAN standard.

10. The radio access network of claim 1, wherein the first cascaded near-real time radio access network intelligent controller includes a node ID that identifies the capability to perform E2 node functions in E2 communication with the second cascaded near-real time radio access network intelligent controller.

11. The radio access network of claim 1, wherein the network is operable to add a third cascaded near-real time radio access network intelligent controller by establishing network communication between the third cascaded near-real time radio access network intelligent controller and the first cascaded near-real time radio access network intelligent controller, wherein the third cascaded near-real time radio access network intelligent controller executes an E2 node function in response to the first cascaded near-real time radio access network intelligent controller communicating via the E2 termination.

12. A method of servicing E2 nodes in a mobile communication network, the method comprising:
establishing a parent cascaded near-real time radio access network intelligent controller;
establishing network communication between the parent cascaded near-real time radio access network intelligent controller to a child cascaded near-real time radio access network intelligent controller via an E2 termination;
servicing an E2 node through network communication to the child cascaded near-real time radio access network intelligent controller via the E2 termination; and
performing an E2 node function via an E2 agent of the child cascaded near-real time radio access network intelligent controller in response to a request from the parent cascaded near-real time radio access network intelligent controller via the E2 termination.

13. The method of claim 12, wherein a non-real time radio access network intelligent controller is in network communication with the parent cascaded near-real time radio access network intelligent controller via an A1 termination.

14. The method of claim 12, further comprising the parent cascaded near-real time radio access network intelligent controller executing a radio area access network function from the child cascaded near-real time radio access network intelligent controller via the E2 termination of the parent cascaded near-real time radio access network intelligent controller to the E2 agent of the child cascaded near-real time radio access network intelligent controller.

15. The method of claim 12, wherein the E2 node is one of a plurality of E2 nodes supported by the child cascaded near-real time radio access network intelligent controller.

16. The method of claim 12, wherein the child cascaded near-real time radio access network intelligent controller is compatible with the O-RAN standard.

17. A cascaded near-real time radio access network intelligent controller comprising:
an E2 termination allowing communication to an E2 node and another cascaded near-real time radio access intelligent controller through the network;
a controller executing a radio access network function for the E2 node through the E2 termination; and
an E2 agent component allowing performance of an E2 function by the controller in response to requests from the another cascaded near-real time radio access network intelligent controller via the E2 termination.

18. The cascaded near-real time radio access network intelligent controller of claim 17, wherein the cascaded near-real time radio access network intelligent controller is compatible with the O-RAN standard.

19. The cascaded near-real time radio access network intelligent controller of claim 17, further comprising a node ID that identifies the capability to perform E2 node functions, wherein the controller sends the node ID in E2 communications with the another cascaded near-real time radio access intelligent controller.

20. The cascaded near-real time radio access intelligent controller of claim 17, further comprising an A1 termination allowing communication to the another cascaded near-real time radio access intelligent controller through the network, wherein the controller is operable to perform an A1 function in response to the another cascaded near-real time radio access network intelligent controller communicating via the A1 termination.
